(19) United States
(12) Patent Application Publication
(10) Pub. No.: US 2008/0224821 A1
(43) Pub. Date: Sep. 18, 2008

(54) METHOD AND APPARATUS FOR PERFORMING CROSS CERTIFICATION FOR USING WIRELESS DEVICE

(75) Inventor: Jong-ho PARK, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/942,777

(22) Filed: Nov. 20, 2007

(30) Foreign Application Priority Data
Mar. 14, 2007 (KR) 2007-25137

(51) Int. Cl. G05B 19/00

(52) U.S. Cl. 340/5.1

(57) ABSTRACT

A method and apparatus for performing cross certification for using a wireless device. By recognizing a connection request of a wireless device, obtaining specific identification (ID) of the wireless device, receiving information on the wireless device through a wireless interface, registering the information on the wireless device in a host using the received information, and transmitting certification information combined with the obtained specific ID and connection information to the wireless device, cross certification between the host and the wireless device which performs wireless communication can be automatically performed without additional manipulation, such as connecting a physical device or inputting a value by a user.

### CROSS-REFERENCE TO RELATED APPLICATION

This application claims the benefit of Korean Patent Application No. 2007-25137, filed in the Korean Intellectual Property Office on Mar. 14, 2007, the disclosure of which is incorporated herein by reference.

### BACKGROUND OF THE INVENTION

1. Field of the Invention

Aspects of the present invention relate to a method and apparatus for performing cross certification for using a wireless device and, more particularly, to a method and apparatus for performing initial cross certification for using a wireless device that provides a wireless interface such as Bluetooth or ultra-wideband (UWB).

2. Description of the Related Art

A wireless device that provides a wireless interface, such as Bluetooth or UWB, requires initial cross certification and recognition with a host to allow use of the wireless device before wireless communication is performed between the wireless device and the host. Conventionally, initial cross certification has been performed using a method of connecting a cable between the host and the wireless device. Alternatively, cross-certification has been performed by requesting the user to input the cross-certification keys to both the host and the wireless device when the wireless device requests the host to perform cross certification, that is, when the wireless device sends device information to the host.

As such, conventional cross certification for using a wireless device may cause inconvenience in that an additional device such as a cable has to be prepared or a user has to input/register a certification value.

### SUMMARY OF THE INVENTION

Aspects of the present invention provide a method and apparatus for performing cross certification when using a wireless device. By recognizing a connection request of a wireless device, obtaining specific identification (ID) of the wireless device, receiving information on the wireless device through a wireless interface, registering the information about the wireless device in a host using the received information, and transmitting certification information combined with the obtained ID and connection information to the wireless device, cross certification between the host and the wireless device can be automatically performed without additional manipulation, such as connecting a physical device or inputting a value by a user.

Aspects of the present invention also provide a computer readable recording medium having recorded thereon a computer program for executing the above-described method.

The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art.

According to an aspect of the present invention, a method of performing cross certification for using a wireless device in connection with a host is provided. The method includes recognizing a connection request of the wireless device and obtaining specific identification (ID) of the wireless device; receiving information on the wireless device through a predetermined wireless interface; registering the information on the wireless device in the host using the received information; and transmitting certification information combined with the obtained specific ID and connection information to the wireless device.

According to another aspect of the present invention, a computer readable recording medium is provided. The computer readable medium has recorded thereon a computer program to execute a method of performing cross certification for using a wireless device in connection with a host according to aspects of the present invention.

According to another aspect of the present invention, a method of performing cross certification from a wireless device to a host is provided. The method includes requesting a wireless connection to the host; transferring information on the wireless device through a predetermined wireless interface; receiving certification information combined with specific identification (ID) of the wireless device and connection information from the host; and performing cross certification for data communication using the received information.

According to another aspect of the present invention, a computer readable recording medium is provided. The computer readable medium has recorded thereon a computer program to execute a method of performing cross certification from a wireless device to a host according to aspects of the present invention.

According to another aspect of the present invention, an apparatus to perform cross certification for use of a wireless device is provided. The apparatus includes a non-contact recognition module to recognize a connection request of the wireless device and to obtain specific identification (ID) of the wireless device; a reception unit to receive information on the wireless device through a predetermined wireless interface; an information setting unit to register the information on the wireless device in the host using the received information; and a transmission unit to transmit certification information combined with the obtained specific ID and connection information to the wireless device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a method of performing cross certification for using a wireless device in connection with a host, according to an embodiment of the present invention; and

FIG. 2 is a diagram illustrating an apparatus for performing cross certification for using a wireless device, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

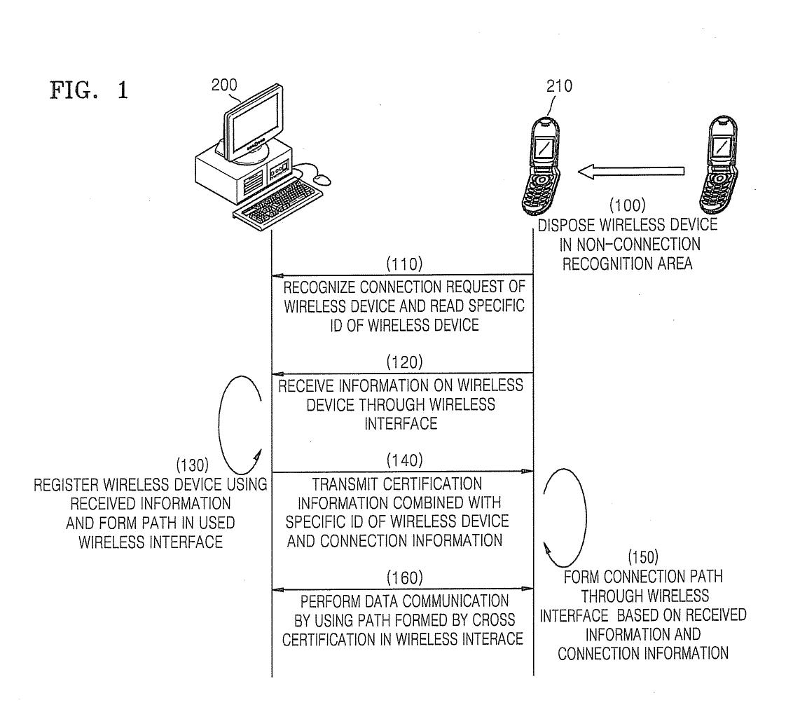

FIG. 1 is a diagram illustrating a process of performing cross certification for using a wireless device 210 in connection with a host 200, according to an embodiment of the present invention. In operation 100, the wireless device 210 is disposed in a non-connection recognition area. In order to use the wireless device 210 in connection with the host 200, a user disposes the wireless device 210 in the non-connection recognition area within a predetermined distance from the host 200.

According to an embodiment of the present invention, the host 200 uses a non-contact recognition module in order to recognize the wireless device 210. The non-connection recognition area is the maximum distance that allows the non-contact recognition module connected to the host 200 to recognize the wireless device 210. When the wireless device 210 is disposed within the predetermined distance from the host 200, the host 200 recognizes the wireless device 210 using the non-contact recognition module connected to the host 200. Examples of the non-contact recognition module include a radio-frequency identification (RFID) reader, an Infrared Data Association (IrDA) transceiver module, a Bluetooth module, and a barcode reader.

The wireless device 210 includes at least one of an RFID tag, an IrDA transceiver module, a Bluetooth module, or a barcode, to communicate with the non-contact recognition module. According to an embodiment of the present invention, the RFID reader, the IrDA transceiver module, the Bluetooth module, or the barcode reader is used as the non-contact recognition module connected to the host 200, but the present invention is not limited thereto. Any module that can recognize the wireless device 210 without requiring a physical connection between the host 200 and the wireless device 210 can also be used. The wireless device 210 according to an embodiment of the present invention performs data communication with the host 200 through a wireless interface. Examples of the wireless device 210 include a mouse, a keyboard, a storage medium, a camera, a camcorder, an MP3 player, a portable multimedia player (PMP), a mobile phone, a personal entertainment device, and a personal digital assistant (PDA).

In operation 110, the host 200 recognizes a connection request of the wireless device 210 and reads specific identification (ID) of the wireless device 210. When the wireless device 210 is disposed in the non-connection recognition area, the host 200 recognizes this as the wireless device 210 requesting the host 200 for a connection and reads the specific ID of the wireless device 210. The host 200 can recognize that when the wireless device 210 is disposed in the non-connection recognition area and the host 200 receives a predetermined signal from the wireless device 210, the wireless device 210 is issuing the connection request. After recognizing the connection request of the wireless device 210, the host 200 identifies the wireless device 210 by reading the specific ID of the wireless device 210.

In operation 120, the host 200 receives information on the wireless device 210 through the wireless interface. After recognizing the wireless device 210 by reading the specific ID of the wireless device 210, the host 200 receives the information about the wireless device 210, which is necessary for registering the wireless device 210 in the host 200, from the wireless device 210. In operation 130, the host 200 registers the information on the wireless device 210 and forms a path for data communication with the wireless device 210 in the wireless interface.

In operation 140, the host 200 transmits certification information combined with the specific ID of the wireless device 210 to the wireless device 210 along with connection information. The host 200 combines the specific ID of the wireless device 210 obtained from the wireless device 210 and the certification information and transmits the connection information, including information on the path formed in the wireless interface for data communication, to the wireless device 210. The certification information combined with the specific ID of the wireless device 210 and the connection information can be transmitted using the path formed in the wireless interface.

In operation 150, the wireless device 210 forms a connection path through the wireless interface based on the certification information and the connection information received from the host 200. The host 200 and the wireless device 210 may perform cross certification for data communication by performing the above-described process. In operation 160, data communication is performed using the path formed by the cross certification in the wireless interface.

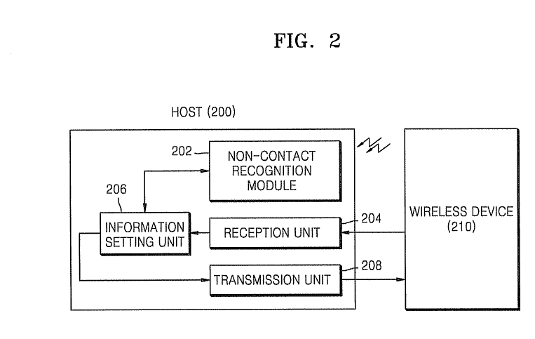

FIG. 2 is a diagram illustrating a host 200 for performing cross certification to use a wireless device 210, according to an embodiment of the present invention. The host 200 includes a non-contact recognition module 202, a reception unit 204, an information setting unit 206, and a transmission unit 208. According to other aspects of the present invention, the host 200 may include additional or different units. Similarly, one or more of the above units may be combined into a single component. The host 200 may be a desktop computer, laptop computer, or similar apparatus.

When the wireless device 210 is disposed in a non-connection recognition area where the wireless device 210 can recognize the non-contact recognition module 202, the non-contact recognition module 202 recognizes the wireless device 210 and a connection request of the wireless device 210 and reads the specific ID of the wireless device 210. The connection request of the wireless device 210 can be recognized by the non-contact recognition module 202 when the wireless device 210 and the non-contact recognition module 202 are disposed in the non-connection recognition area or the non-contact recognition module 202 receives a predetermined signal from the wireless device 210 generated by, for example, inputting a key.

The host 200 recognizes the connection request of the wireless device 210 through the non-contact recognition module 202 and identifies the wireless device 210 by reading specific ID of the wireless device 210. Examples of the non-contact recognition module 202 are an RFID reader, an IrDA transceiver module, and a barcode reader. The wireless device 210 may include at least one of an RFID tag, an IrDA transceiver module, a Bluetooth module, or a barcode to communicate with the non-contact recognition module 202. According to an embodiment of the present invention, the RFID reader, the IrDA transceiver module, the Bluetooth module, or the barcode reader is used as the non-contact recognition module 202 connected to the host 200, but the present invention is not limited thereto. Any other module that can recognize the wireless device 210 without connection can also be used. The wireless device 210 according to an embodiment of the present invention performs data communication with the host 200 through a wireless interface. The wireless device 210 may be, but is not limited to, at least one of a mouse, a keyboard, a storage medium, a camera, a camcorder, an MP3 player, a PMP, a mobile phone, a personal entertainment device, or a PDA. As used herein, “at least one of” indicates one item or a combination of two or more items.

The reception unit 204 receives information on the wireless device 210 through the wireless interface. After recognizing the wireless device 210 by reading the specific ID of the wireless device 210, the host 200 receives the information on the wireless device 210 through the reception unit 204.

The information setting unit 206 registers the information on the wireless device 210 in the host 200 using the information received from the wireless device 210 and forms a path in the wireless interface used to receive the information on the wireless device 210. By registering the information of the wireless device 210 in the host 200, the recognized wireless device 210 can be used in connection with the host 200.

The transmission unit 208 transmits certification information combined with the specific ID of the wireless device 210 and connection information including information on the path formed in the wireless interface for data communication to the wireless device 210. The certification information and the connection information can be transmitted using the path formed by the information setting unit 206 in the wireless interface.

The wireless device 210 forms a connection path through the wireless interface based on the certification information and the connection information received from the host 200. As such, when cross certification for data communication between the host 200 and the wireless device 210 is performed, data communication is performed using the path formed by the cross certification in the wireless interface.

Various components of the host 200 illustrated in FIG. 2 can be integrated into a single control unit, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, DVDs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to aspects of the present invention, by recognizing a connection request of a wireless device, obtaining specific ID of the wireless device, receiving information on the wireless device through a wireless interface, registering the information on the wireless device in a host using the received information, and transmitting certification information combined with the obtained ID and connection information to the wireless device, cross certification between the host and the wireless device which performs wireless communication can be performed automatically without a need for additional manipulation, such as connecting a physical device or inputting a value by a user.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of performing cross certification to use a wireless device in connection with a host, the method comprising:
recognizing a connection request of the wireless device and obtaining specific identification (ID) of the wireless device;
receiving information on the wireless device through a predetermined wireless interface;
registering the information on the wireless device in the host using the received information; and
transmitting certification information combined with the obtained specific ID and connection information to the wireless device.

2. The method of claim 1, wherein the recognizing of the connection request and the obtaining of the specific ID is performed when the wireless device and the host are disposed within a predetermined distance.

3. The method of claim 2, wherein the recognizing of the connection request and the obtaining of the specific ID is performed by a non-contact recognition module connected to the host.

4. The method of claim 3, wherein the non-contact recognition module is at least one of a radio-frequency identification (RFID) reader, an Infrared Data Association (IrDA) transceiver module, a Bluetooth module, or a barcode reader.

5. The method of claim 1, wherein the wireless device is at least one of a mouse, a keyboard, a storage medium, a camera, a camcorder, an MP3 player, a portable multimedia player (PMP), or a personal digital assistant (PDA).

6. The method of claim 1, wherein:
the registering of the information comprises forming a path for data communication in the wireless interface; and
the transmitting of the certification information is performed using the path formed in the wireless interface.

7. The method of claim 1, wherein the connection information includes information on the path formed in the wireless interface.

8. The method of claim 7, further comprising:
performing data communication with the wireless device using the path formed in the wireless interface.

9. A computer readable recording medium having recorded thereon a computer program to execute the method of claim 1.

10. A method of performing cross certification from a wireless device to a host, the method comprising:
requesting a wireless connection with the host;
transferring information on the wireless device through a predetermined wireless interface;
receiving certification information combined with specific identification (ID) of the wireless device and connection information from the host; and
performing cross certification for data communication using the received information.

11. The method of claim 10, wherein the requesting of the wireless connection is performed when the wireless device and the host are disposed apart from each other within a predetermined distance.

12. An apparatus to perform cross certification with a wireless device, the apparatus comprising:
a non-contact recognition module to recognize a connection request of the wireless device and to obtain specific identification (ID) of the wireless device;
a reception unit to receive information on the wireless device through a predetermined wireless interface;
an information setting unit to register the information on the wireless device in the host using the received information; and
a transmission unit to transmit certification information combined with the obtained specific ID to the wireless device along with connection information.

13. The apparatus of claim 12, wherein the non-contact recognition module recognizes the connection request of the wireless device and obtains the specific ID of the wireless device when the wireless device and the host are disposed apart from each other by a predetermined distance.

14. The apparatus of claim 12, wherein the non-contact recognition module is at least one of a radio-frequency identification (RFID) reader, an Infrared Data Association (IrDA) transceiver module, a Bluetooth module, or a barcode reader.

15. The apparatus of claim 12, wherein the wireless device is at least one of a mouse, a keyboard, a storage medium, a camera, a camcorder, an MP3 player, a portable multimedia player (PMP), or a personal digital assistant (PDA).

16. The method of claim 10, wherein the requesting of the wireless connection comprises generating a predetermined signal.

17. The method of claim 1, wherein the connection request is a predetermined signal.

18. A method of performing cross-certification between a host device and a wireless device without requiring a physical connection or user input, the method comprising:
receiving a connection request from a wireless device via a predetermined wireless signal;
receiving information on the wireless device including a specific identification (specific ID);
registering the wireless device using the received information; and
transmitting certification information along with the specific ID to the wireless device.

19. The method of claim 18, wherein:
the registering of the wireless device comprises creating a wireless communication path to the wireless device; and
the transmitting of the certification information comprises transmitting the certification information and the specific ID via the wireless communication path.
